(19) United States
(12) Patent Application Publication
(10) Pub. No.: US 2025/0001804 A1
(43) Pub. Date: Jan. 2, 2025

(54) RUBBERIZED METALLIC STRENGTH MEMBER AND PNEUMATIC VEHICLE TIRE

(71) Applicant: Continental Reifen Deutschland GmbH, Hannover (DE)

(72) Inventors: Thomas Kramer, Herford (DE); Joseph Guardalabene, Hannover (DE); Daniel De Castro Pinho, Hohenhameln (DE); Michael Schunack, Hannover (DE)

(73) Assignee: Continental Reifen Deutschland GmbH, Hannover (DE)

(21) Appl. No.: 18/689,255

(22) PCT Filed: Aug. 15, 2022
(86) PCT No.: PCT/DE2022/200184

§ 371 Date: Mar. 5, 2024

(30) Foreign Application Priority Data
Sep. 6, 2021 (DE) 10 2021 209 766.9

(51) Int. Cl. B60C 9/00; B60C 1/00; C08K 5/47

(52) U.S. Cl. CPC B60C 9/0007; C08K 5/47; B60C 1/0041; B60C 2001/0066; B60C 2009/0014; B60C 2009/0021

(57) ABSTRACT

A metallic strength member rubberized with a sulfur-crosslinkable, essentially cobalt-free rubberization mixture, wherein the metallic strength member is a steel cord containing one or more filaments, wherein the filaments include a steel substrate filament and a coating that partly or completely covers the steel substrate filament, wherein the coating includes brass consisting of copper and zinc, and wherein the coating is enriched with iron in the form of particles having a size between 10 and 10 000 nm in the brass. In order to optimize vulcanization times, the rubberization mixture contains 0.5 to 3 phr of at least one sulfenimide accelerator and/or at least one dibenzylamine-based sulfenamide accelerator.

### CROSS-REFERENCE TO RELATED APPLICATIONS

The present application is a National Stage Application under 35 U.S.C. § 371 of International Patent Application No. PCT/DE2022/200184 filed on Aug. 15, 2022, and claims priority from German Patent Application No. 10 2021 209 766.9 filed on Sep. 6, 2021, the disclosures of which are herein incorporated by reference in their entireties.

### TECHNICAL FIELD

The invention relates to a metallic strength member rubberized with a sulfur-crosslinkable, essentially cobalt-free rubberization mixture, wherein the metallic strength member is a steel cord containing one or more filaments, wherein the filaments comprise a steel substrate filament and a coating that partly or completely covers the steel substrate filament, wherein the coating comprises brass consisting of copper and zinc, and wherein the coating is enriched with iron in the form of particles having a size between 10 and 10 000 nm in the brass.

The invention further relates to a pneumatic vehicle tire including such a metallic strength member rubberized with a sulfur-crosslinked rubberization mixture.

### BACKGROUND

The adhesion of steel cords to a rubber matrix is possible via brass (on the steel) and sulfur (from the rubberization mixture).

Sulfur-crosslinkable rubberization mixtures for brassed steel cord generally contain cobalt-based bonding systems that usually include methylene acceptor-methylene donor pairs, for example. The cobalt compounds, generally organic cobalt salts, are intended to inhibit excessively fast buildup of zinc oxide and copper sulfide layers on the brass layer of the steel cord that form during the aging of the rubber-steel cord composite. The zinc oxide and copper sulfide layers can become brittle over the course of their lifetime and hence lead to reduced adhesion between steel cord and rubber. The cobalt compounds lead to an improvement in adhesion under stress in a moist and hot environment.

However, the use of cobalt salts for rubberization mixtures is also afflicted by some disadvantages. Organic cobalt salts can firstly act as oxidation catalysts and therefore lead to unwanted aging processes within the mixture layers. Secondly, cobalt and salts thereof are classified as harmful to the environment, and the degradation of cobalt and the production of its salts damage the environment. Moreover, there is a growing demand on the global scale for cobalt in the battery industry. It is therefore to be expected that the currently already high costs of cobalt will rise further in the next few years.

There is therefore an effort to reduce the level of cobalt in rubberization mixtures.

In order to achieve this, for example, steel cords having specific alloys already containing cobalt on their surface have been developed. Such steel cords with cobalt-containing alloys are described, for example, in EP 2 516 729 B1. In this way, however, cobalt consumption is merely reduced. The cobalt is moved from the mixture side to the side of the steel cord.

Another way of dispensing with cobalt in rubberization mixtures is disclosed by WO 2020/156967 A1. This document specifies metallic strength members of the type specified at the outset that have been rubberized with a sulfur-crosslinkable, essentially cobalt-free rubberization mixture, processes for production thereof and use thereof. The strength members have a brass coating doped with iron particles in the nanometer range. Such strength members are compatible with rubberization mixtures that are essentially free of cobalt and can be used in pneumatic vehicle tires, for example.

### SUMMARY

If the cobalt compounds are removed from the rubberization mixtures, however, it has been found that there is a change in the mixture properties. The vulcanization times in particular become much longer if the composition of the mixture is otherwise unchanged. This is often undesirable since the rubberization of the strength members, for example of the belt rubberization in pneumatic vehicle tires, is frequently the region in the rubber product that determines the heating time, and an extension of the heating time of the rubberization mixture results in an extension of the heating time for the overall product with the resulting problems, such as overvulcanization of individual regions and disadvantages in economic viability. If this extension of the vulcanization times is counteracted, for example, via greater amounts of vulcanization accelerator, it may be the case that the crosslinking proceeds so quickly at the start that it is not possible for an adequate tie layer to form between strength member and embedding rubberization mixture.

It is an object of the invention to provide a metallic strength member of the type specified at the outset that has been rubberized with a sulfur-crosslinkable, essentially cobalt-free rubberization mixture, which has been optimized with regard to vulcanization times and at the same time has good strength member-rubber adhesion.

The object is achieved in accordance with the invention in that the rubberization mixture contains 0.5 to 3 phr (parts by weight, based on 100 parts by weight of all rubbers in the mixture) of at least one sulfenimide accelerator and/or at least one dibenzylamine-based sulfenamide accelerator.

An essentially cobalt-free rubberization mixture is understood to mean a rubberization mixture which is essentially free of cobalt or organic cobalt compounds. The cobalt content, measured by x-ray fluorescence spectroscopy, in the vulcanized rubberization mixture is less than 0.01% by weight based on the weight of the vulcanized rubber mixture.

The unit “phr” (parts per hundred parts of rubber by weight) used in this document is the standard unit of quantity for mixture recipes in the rubber industry. The dosage of the parts by weight of the individual substances is always based on 100 parts by weight of the total mass of all rubbers present in the mixture. The mass of all rubbers present in the mixture sums to 100.

It has been found that, surprisingly, the use of a sulfenimide accelerator and/or a specific dibenzylamine-based sulfenamide accelerator in the specified amounts, even without the presence of cobalt, can achieve an optimal balance between initial crosslinking without excessive speed (not too short a scorch time t₁₀) and final crosslinking with sufficient speed (not too long an optimal vulcanization time t₉₀).

The metallic strength member that has been rubberized in accordance with the invention also has the benefit of good adhesion even after aging, especially steam aging.

In addition, the metallic strength member that has been rubberized in accordance with the invention offers the environmental and economic benefits of a cobalt-free mixture and a cobalt-free strength member.

The adhesion between strength member and embedding rubberization mixture can be further improved when the coating is enriched with iron in the form of particles having a size between 20 and 5000 nm in the brass.

In a preferred development of the invention, the brass in the coating comprises at least 63% by weight of copper, the balance being zinc. According to the invention, the amount of iron is not encompassed by the definition of the brass. The coating of the strength member in that case comprises brass and iron.

It is preferable that the amount of iron in the coating is not less than 1% by weight and less than 10% by weight, more preferably not less than 3% by weight and less than 9% by weight, by comparison with the total mass of brass and iron. In the case of amounts of iron of more than 10% by weight, problems can arise in the drawing of the filaments.

For better processability of the filaments, the coating is essentially free of zinc-iron alloys.

The rubberization mixture contains 0.5 to 3 phr, preferably 1 to 2.5 phr, of at least one sulfenimide accelerator and/or at least one dibenzylamine-based sulfenamide accelerator.

Sulfenimide accelerators are vulcanization accelerators based on primary amines. By contrast, sulfenamide accelerators such as DCBS (N,N′-dicyclohexyl-2-benzothiazolesulfenamide) or MBS (N-oxydiethylene-2-benzothiazolesulfenamide) are based on secondary amines. There may be one or more sulfenimide accelerators in the mixture.

For a balanced ratio of scorch time t₁₀ and optimal vulcanization time t₉₀, the sulfenimide accelerator is N-tert-butyl-2-benzothiazolesulfenimide (TBSI, IUPAC name: N,N-bis(1,3-benzothiazol-2-ylsulfanyl)-2-methylpropan-2-amine). The use of the sulfenimide accelerator N-tert-butyl-2-benzothiazolesulfenimide (TBSI) as vulcanization accelerator in cobalt-containing rubberization mixtures is known, for example, from US 2010/0200141 A1 and U.S. Pat. No. 6,120,911.

The dibenzylamine-based sulfenamide accelerators are substances that derive from 2-mercaptobenzothiazole and in which a dibenzylamine has been attached to the mercapto sulfur. There may be one or more dibenzylamine-based sulfenamide accelerators in the mixture.

In a preferred development of the invention, the dibenzylamine-based sulfenamide accelerator is N,N′-dibenzyl-2-benzothiazolesulfenamide (DBBS).

In order to further improve the durability of the rubber-metal adhesion with regard to oxidative aging processes, it has been found to be advantageous when the rubberization mixture contains 2 to 10 phr of zinc oxide.

In order to further improve adhesion, the rubberization mixture may contain methylene acceptor-methylene donor pairs in customary amounts. Methylene acceptors used may be resorcinol-based methylene acceptors for specific novolak resins, such as Alnovol® PN 760/Past, from Allnex Netherlands B. V. Methylene donors/formaldehyde donors present may, for example, be etherified melamine resins. Etherified resins include, for example, hexamethoxymethylmelamine (HMMM) and hexamethylenetetramine (HMT).

In addition, the rubberization mixture may contain further adhesion stabilizers that are effective after vulcanization, such as sodium hexamethylene-1,6-bisthiosulfate dihydrate (NaO₃SS(CH₂)₆SSO₃Na·2 H₂O).

The sulfur-crosslinkable rubberization mixture contains further constituents customary in the rubber industry, in particular at least one rubber.

Employable rubbers include diene rubbers. Diene rubbers include all rubbers having an unsaturated carbon chain which at least partially derive from conjugated dienes.

The rubberization mixture may comprise polyisoprene (IR, NR) as diene rubber. This may be either cis-1,4-polyisoprene or 3,4-polyisoprene. Preference is given, however, to the use of cis-1,4-polyisoprenes with a cis-1,4 content>90% by weight. Such a polyisoprene is firstly obtainable by stereospecific polymerization in solution with Ziegler-Natta catalysts or using finely divided lithium alkyls. Secondly, natural rubber (NR) is one such cis-1,4-polyisoprene, the cis-1,4 content in natural rubber being greater than 99% by weight. Natural rubber is understood to mean rubber that can be obtained by harvesting from sources such as rubber trees (Hevea brasiliensis) or non-rubber tree sources (for example guayule or dandelion (e.g. Taraxacum koksaghyz)).

If the rubber mixture contains polybutadiene (BR) as the diene rubber this may be cis-1,4-polybutadiene. Preference is given to the use of cis-1,4-polybutadiene with a cis-1,4 content greater than 90% by weight, which is producible, for example, by solution polymerization in the presence of rare earth catalysts.

Further diene rubbers that may be employed include vinyl-polybutadienes and styrene-butadiene copolymers. The vinyl-polybutadienes and styrene-butadiene copolymers may be solution-polymerized (styrene)-butadiene copolymers (S-(S) BR) having a styrene content, based on the polymer, of about 0% to 45% by weight and a vinyl content (content of 1,2-bonded butadiene, based on the total polymer) of 10% to 90% by weight, which may be produced using lithium alkyls in organic solvent for example. The S-(S) BR may also be coupled and endgroup-modified. However, it is also possible to employ emulsion-polymerized styrene-butadiene copolymers (E-SBR) and mixtures of E-SBR and S-(S) BR. The styrene content of the E-SBR is about 15% to 50% by weight, and it is possible to use the products known from the prior art that have been obtained by copolymerization of styrene and 1,3-butadiene in aqueous emulsion.

The diene rubbers used in the mixture, especially the styrene-butadiene copolymers, can also be used in partly or fully functionalized form. The functionalization can be effected with groups which can interact with the fillers used, especially with fillers bearing OH groups. These may be for example functionalizations with hydroxyl groups and/or epoxy groups and/or siloxane groups and/or amino groups and/or phthalocyanine groups and/or carboxy groups and/or silane sulfide groups. Alternatively or in addition the diene rubbers may also be coupled.

However, in addition to the recited diene rubbers the mixture may also contain other rubber types such as for example styrene-isoprene-butadiene terpolymer, butyl rubber, halobutyl rubber or ethylene-propylene-diene rubber (EPDM).

Regenerate (reclaim) may also be added to the rubberization mixture as a processing aid and to make the mixture more cost-effective.

The rubberization mixture may comprise different fillers, such as carbon blacks, silicas, aluminosilicates, chalk, starch, magnesium oxide, titanium dioxide or rubber gels, in customary amounts, where the fillers may be used in combination.

If carbon black is used in the rubber mixture the types employed are preferably those having a CTAB surface area (to ASTM D 3765) of more than 30 m²/g. These are readily incorporable and ensure low heat buildup.

If silicas are present in the mixture these may be silicas customary for tire rubber mixtures. It is particularly preferable to employ a finely divided, precipitated silica having a CTAB surface area (to ASTM D 3765) of 30 to 350 m²/g, preferably of 110 to 250 m²/g. Employable silicas include both conventional silicas, such as those of the VN3 type (trade name) from Evonik, or highly dispersible silicas known as HD silicas (e.g. Ultrasil 7000 from Evonik).

If the rubberization mixture contains silica or other polar fillers, silane coupling agents may be added to the mixture in order to improve processability and to bind the polar filler to the rubber. The silane coupling agents react with the surface silanol groups of the silica or other polar groups during the mixing of the rubber/the rubber mixture (in situ) or in the context of a pretreatment (premodification) even before addition of the filler to the rubber. Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH₂ or —Sₓ—(with x=2−8). Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of the sulfides having 1 to 8 sulfur atoms with different contents of the various sulfides. The silane coupling agents may also be added here as a mixture with industrial carbon black, for example TESPT on carbon black (trade name: X50S from Evonik). Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is possible to use, for example, silanes which are sold under the NXT name in a number of variants by Momentive, USA, or those that are sold under the VP Si 363 name by Evonik Industries. Also usable are “silated core polysulfides” (SCPs, polysulfides with a silylated core), which are described, for example, in US 20080161477 A1 and EP 2 114 961 B1.

Furthermore, the rubberization mixture may comprise standard additives in customary proportions by weight. These additives include plasticizers, for example glycerides, factices, hydrocarbon resins, aromatic, naphthenic or paraffinic mineral oil plasticizers (for example MES (mild extraction solvate) or TDAE (treated distillate aromatic extract)), oils based on renewable raw materials (for example rapeseed oil, terpene oils (for example orange oils) or factices), what are called BTL oils (as disclosed in DE 10 2008 037714 A1) or liquid polymers (for example liquid polybutadiene); aging inhibitors, for example N-phenyl-N′-(1,3-dimethylbutyl)-p-phenylenediamine (6PPD), N-isopropyl-N′-phenyl-p-phenylenediamine (IPPD), 2,2,4-trimethyl-1,2-dihydroquinoline (TMQ) and other substances, as known for example from J. Schnetger, Lexikon der Kautschuktechnik [Lexicon of Rubber Technology], 2nd edition, Hüthig Buch Verlag, Heidelberg, 1991, pages 42-48, activators, for example fatty acids (for example stearic acid), waxes, tackifier resins, for example hydrocarbon resins and rosin, and mastication aids, for example 2,2′-dibenzamidodiphenyldisulfide (DBD).

The vulcanization is performed in the presence of sulfur and/or sulfur donors, and some sulfur donors can simultaneously act as vulcanization accelerators. Sulfur or sulfur donors are added to the rubberization mixture in the amounts commonly used by those skilled in the art (0.4 to 8 phr) in the last mixing step. Preference is given to using sulfur in an amount of 2 to 5 phr. Sulfur is preferably used in oil-extended form. In this way, the sulfur can be incorporated and dispersed more easily and uniformly.

In addition to the sulfenimide accelerators and the dibenzylamine-based sulfenamide accelerators, the rubberization mixture may also contain further vulcanization-influencing substances such as further vulcanization accelerators, vulcanization retarders and vulcanization activators in customary amounts. The rubberization mixture preferably contains, aside from the sulfenimide accelerators and the dibenzylamine-based sulfenamide accelerators, less than 0.5 phr of other vulcanization accelerators.

The rubberization mixture is produced in a conventional manner, by first generally preparing a base mixture containing all the constituents except for the vulcanization system (sulfur and vulcanization-influencing substances), in one or more mixing stages, and subsequently producing the finished mixture by adding the vulcanization system. The mixture is then subjected to further processing.

The rubberized strength members can be used in a wide variety of rubber products including strength members. These rubber products may include for example tires, drive belts, conveyor belts, hoses, rubberized fabrics or air springs. The tires may be car tires, van tires, truck tires, industrial tires, bicycle tires, agricultural vehicle tires or aircraft tires.

Preference is given to using the rubberized metallic strength members in pneumatic vehicle tires. The pneumatic vehicle tires are preferably car tires, van tires or truck tires.

The rubberized metallic strength members may be used in the form of a wide variety of different tire components, such as the bead core, the bead covers, the bead reinforcers, the belt, the carcass or the belt bandages, and it is also possible for multiple components within a tire to include the metallic strength members rubberized in accordance with the invention. The pneumatic vehicle tires of the invention are produced by processes known to those skilled in the art.

It is preferably the belt and/or the carcass of the pneumatic vehicle tire that comprises the rubberized metallic strength members. The good adhesion values between strength members and rubberization mixture, even with aging, lead to a long lifetime of the pneumatic vehicle tire, and the pneumatic vehicle tire can be produced in an economically viable manner.

The invention encompasses all advantageous embodiments that are reflected in the claims inter alia. The invention especially also encompasses embodiments which result from a combination of different features, for example constituents of the rubberization mixture, with different levels of preference for these features so that the invention also comprises a combination of a first feature described as “preferred” or described in the context of an advantageous embodiment with a further feature described for example as “particularly preferred”.

### DETAILED DESCRIPTION

The invention is now to be elucidated in detail with reference to the table that follows.

Table 1 gives example mixtures for a rubberization of metallic strength members of a pneumatic vehicle tire.

In the mixtures in the table, the vulcanization accelerator and the cobalt stearate were varied.

The mixtures were produced under customary conditions to produce a base mixture and subsequently the finished mixture in a tangential laboratory mixer.

The conversion times for 10% and 90% conversion (t₁₀: scorch time, t₉₀, optimal vulcanization time) were determined using a rotorless vulcameter (MDR=moving disk rheometer) according to DIN 53 529 for vulcanization at 160° C.

In addition, the mixtures from table 1 were used to conduct tests of adhesion on conventional brassed steel cord A (2×0.3 HT, brass: 63.5% by weight of copper, 36.5% by weight of zinc, iron content of the coating: 0% by weight) and on inventive iron-doped, brassed steel cord B (2×0.3 HT, where the content is composed of 64.1% by weight of copper, 32.6% by weight of zinc, 3.3% by weight of iron having a particle size distribution of the iron particles between 20 and 5000 nm) to ASTM 2229/D1871 without aging and after saturated steam aging for five days at 105° C. (test specimen production: vulcanization: 30 min, 150° C., embedded length in the rubberization mixture: 10 mm, pull-out speed: 125 mm/min). The pull-out force and coverage were determined. For the pull-out force, the value of mixture 1 was taken as 100%; the values of the other mixtures were based on mixture 1.

TABLE 1

| | Unit | 1 | 2 | 3 | 4 |
|---|---|---|---|---|---|
| Constituents | | | | | |
| Natural rubber (polyisoprene) | phr | 100 | 100 | 100 | 100 |
| Carbon black | phr | 63 | 63 | 63 | 63 |
| Plasticizer and aging stabilizer | phr | 9.6 | 9.6 | 9.6 | 9.6 |
| Cobalt stearate | phr | 1.3 | — | — | — |
| Methylene acceptor-methylene | phr | 7.2 | 7.2 | 7.2 | 7.2 |
| donor pair | | | | | |
| Accelerator DCBS | phr | 0.75 | 0.75 | — | — |
| TBSI accelerator | phr | — | — | 1.0 | — |
| DBBS accelerator | phr | — | — | — | 2.2 |
| Sulfur, ext. with 33.8% by wt. of oil | phr | 6.75 | 6.75 | 6.75 | 6.75 |
| Properties | | | | | |
| t₁₀ | min | 1.09 | 0.98 | 0.88 | 0.85 |
| t₉₀ | min | 11.31 | 18.19 | 10.75 | 12.02 |
| Pull-out force (unaged, steel cord A) | % | 100 | 97 | 91 | 102 |
| Coverage (unaged, steel cord A) | % | 100 | 95 | 95 | 92 |
| Pull-out force (unaged, steel cord B) | % | 100 | 99 | 105 | 104 |
| Coverage (unaged, steel cord B) | % | 98 | 96 | 100 | 85 |
| Pull-out force (aged, steel cord A) | % | 80 | 57 | 61 | 58 |
| Coverage (aged, steel cord A) | % | 99 | 92 | 94 | 80 |
| Pull-out force (aged, steel cord B) | % | 87 | 91 | 87 | 91 |
| Coverage (aged, steel cord B) | % | 96 | 97 | 99 | 90 |

It is apparent from the table that optimal vulcanization times can be obtained with mixtures 3 and 4. The optimal vulcanization time t₉₀ in particular, with TBSI or DBBS as accelerator, is in the region of or even below the time for the reference mixture. At the same time, these mixtures, in association with the iron-doped steel cord B, can achieve very good bonding results that are in the region of or even superior to those of reference mixture 1.Abstract

1-10. (canceled)

11. A metallic strength member rubberized with a sulfur-crosslinkable, essentially cobalt-free rubberization mixture,
wherein the metallic strength member is a steel cord containing one or more filaments, wherein the filaments comprise a steel substrate filament and a coating that partly or completely covers the steel substrate filament,
wherein the coating comprises brass consisting of copper and zinc, and
wherein the coating is enriched with iron in the form of particles having a size between 10 and 10,000 nm in the brass,
wherein the rubberization mixture contains 0.5 to 3 phr (parts by weight, based on 100 parts by weight of all rubbers in the mixture) of at least one sulfenimide accelerator and/or at least one dibenzylamine-based sulfenamide accelerator.

12. The rubberized metallic strength member as claimed in claim 11, wherein the coating is enriched with iron in the form of particles having a size between 20 and 5,000 nm in the brass.

13. The rubberized metallic strength member as claimed in claim 11, wherein the brass comprises at least 63% by weight of copper, the balance being zinc.

14. The rubberized metallic strength member as claimed in claim 11, wherein the amount of iron in the coating is not less than 1% by weight and less than 10% by weight, by comparison with the total mass of brass and iron.

15. The rubberized metallic strength member as claimed in claim 11, wherein the amount of iron in the coating is not less than 3% by weight and less than 9% by weight, by comparison with the total mass of brass and iron.

16. The rubberized metallic strength member as claimed in claim 11, wherein the coating is essentially free of zinc-iron alloys.

17. The rubberized metallic strength member as claimed in claim 11, wherein it contains 1 to 2.5 phr of at least one sulfenimide accelerator and/or at least one dibenzylamine-based sulfenamide accelerator.

18. The rubberized metallic strength member as claimed in claim 11, wherein the at least one sulfenimide accelerator is N-tert-butyl-2-benzothiazolesulfenimide (TBSI).

19. The rubberized metallic strength member as claimed in claim 17, wherein the at least one sulfenimide accelerator is N-tert-butyl-2-benzothiazolesulfenimide (TBSI).

20. The rubberized metallic strength member as claimed in claim 11, wherein the at least one dibenzylamine-based sulfenamide accelerator is N,N′-dibenzyl-2-benzothiazolesulfenamide (DBBS).

21. The rubberized metallic strength member as claimed in claim 17, wherein the at least one dibenzylamine-based sulfenamide accelerator is N,N′-dibenzyl-2-benzothiazolesulfenamide (DBBS).

22. A pneumatic vehicle tire including a metallic strength member rubberized with a sulfur-crosslinked rubberization mixture as claimed in claim 11.

23. The pneumatic vehicle tire as claimed in claim 22, wherein the belt and/or carcass contains the rubberized metallic strength member.
